(19) United States
(12) Patent Application Publication
(10) Pub. No.: US 2026/0225782 A1
(43) Pub. Date: Aug. 6, 2026

(54) BIODEGRADABLE BAG AND PREPARATION METHOD THEREOF

(71) Applicant: Gene Benfatti, Bound Brook, NJ (US)

(72) Inventor: Gene Benfatti, Bound Brook, NJ (US)

(21) Appl. No.: 19/047,550

(22) Filed: Feb. 6, 2025

(51) Int. Cl. B65D 65/46; C08J 5/18

(52) U.S. Cl. CPC B65D 65/466; C08J 5/18; B65D 2565/381

(57) ABSTRACT

A biodegradable bag made by mixing polyterephthalic acid-adipic acid-butylene glycol ester and polylactic acid, and then adding modified starch, inorganic filler, coagulant, anti-hydrolysis agent, chain extender, and lubricant to the mixture. The mixture is extruded and granulated to obtain blown film resin which can be blown to form blended films. The bags can be made from blended films. The modified starch is a mixture of corn starch and tapioca starch modified by modifiers. The modifiers include plasticizers, compatibilizers, coupling agents, and anti-migration agents.

### FIELD OF INVENTION

The present application relates to the field of biodegradable polymer materials, and more specifically, to a biodegradable bag, such as a T-shirt bag and film bag for packaging and a method for preparing it.

### BACKGROUND

The widespread use of plastic products, especially plastic film products, has led to environmental problems in the world today and the growing oil crisis. Therefore, the development of biodegradable polymer materials to replace petroleum-based plastics has become a hot spot in current research.

Among the many biodegradable plastics that have been developed, polyethylene terephthalate-adipic acid-butylene glycol (PBAT) is a fully biodegradable aliphatic polyester, which has been widely used in film production due to its good flexibility and processability. However, thin films prepared by PBAT are limited by their low strength and high cost in many applications. Therefore, PBAT is usually blended and modified with other materials to improve its performance and expand its application range.

The high price of PBAT is the main reason for its lesser promotion and application. Certain filling modifications are known to be added with PBAT in the processing process to reduce the cost and achieve the purpose of enhancing and toughening to a certain extent. The filling modifications of PBAT are mainly divided into two categories: starch filling and inorganic filling. The filling modifications can effectively reduce the production cost, so the starch and inorganic-filled PBAT biodegradable blend film materials have attracted much attention and have been widely used in research. However, plasticizer precipitation occurs on the surface of starch-filled PBAT blend film, resulting in a sticky hand feel. In contrast, the heat-sealing performance of inorganic-filled PBAT blend film is poor. Therefore, it is necessary to improve the film performance of starch and inorganically filled PBAT to meet the market demand.

Therefore, a need is appreciated for low-cost, high-quality, high heat-sealing strength, and biodegradable films.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

In one aspect, disclosed is a biodegradable bag made of the following weight parts of raw materials: polyterephthalic acid-adipic acid-butylene glycol ester 55-90 parts, polylactic acid 1-5 parts, modified starch 5-30 parts, inorganic filler 5-30 parts, coagulant 0.5-1.5 parts, hydrolysis agent 0.2-0.6 parts, chain extender 0.1-0.3 parts, and lubricant 0.1-0.5 parts.

In one aspect, the modified starch is a mixture of corn starch and tapioca starch each modified by a modifier. The modifier comprises 2-12 weight parts plasticizer, 0.1-0.3 weight parts compatibilizer, 0.1-1 weight parts coupling agent, and 0.2-0.6 weight parts anti-migration agent. The weight ratio of the corn starch to the tapioca starch is 10-90:10-90. The corn starch and tapioca starch are respectively loaded corn starch and loaded tapioca starch, wherein the loaded corn starch comprises corn starch, rhamnolipid solution, and perilla meal powder in a weight ratio of 1:0.1-0.3:0.2-0.4; wherein the loaded tapioca starch comprises tapioca starch, rhamnolipid solution, and perilla meal in a weight ratio of 1:0.1-0.3:0.2-0.4.

In one aspect, the inorganic filler is talcum powder and/or calcium carbonate. The talcum powder comprises talcum powder particles modified by propolis liquid and hydrophobic cellulose filaments, whereas the calcium carbonate comprises calcium carbonate particles modified by propolis and hydrophobic cellulose filaments. The hydrophobic cellulose filament comprises cellulose filaments modified with methyl silicone oil.

In one aspect, the coagulant comprises sodium polyacrylate and microcrystalline wax in a weight ratio of 1:0.1-0.3. The chain extender is an oligomer of styrene-acrylic acid-propylene methacrylate. The anti-hydrolysis agent is a polymeric carbodiimide anti-hydrolysis agent.

### DETAILED DESCRIPTION

The subject matter will now be described more fully hereinafter by way of specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

“Polyterephthalic acid-adipic acid-butylene glycol ester” refers to a type of biodegradable polyester commonly called “PBAT” (poly(butylene adipate-co-terephthalate)), which is formed by combining terephthalic acid, adipic acid, and butylene glycol through a polycondensation reaction; essentially creating a copolymer with properties derived from both polyethylene terephthalate (PET) and polybutylene adipate (PBA) due to the mixed ester linkages in its structure. The ratio of terephthalic acid to adipic acid can be adjusted to tailor the polymer's properties like flexibility and strength.

To prepare a film with low cost, high quality, high heat-sealing strength, that can be completely biodegradable after use, the application provides a fully biodegradable bag and a preparation method thereof. The biodegradable bag may be a biodegradable T-shirt bag, film bag, and the like.

In certain implementations, disclosed is a fully biodegradable bag containing the following weight parts of raw materials: 55-90 parts of polyterephthalate-adipic acid-butylene glycol, 1-5 parts of polylactic acid, 5-30 parts of modified starch, 5-30 parts of inorganic filler, 0.5-1.5 parts of coagulant, 0.2-0.6 parts of an anti-hydrolysis agent, 0.1-0.3 parts of chain extender, and 0.1-0.5 parts of lubricant. The modified starch may be a mixture of corn starch and tapioca starch modified by a modifier, and the modifier may comprise a raw material of the following weight parts: 2-12 parts plasticizer, 0.1-0.3 parts compatibilizer, 0.1-1 parts coupling agent, and 0.2-0.6 parts anti-migration agent.

Through the adoption of the above-mentioned technical scheme, polyterephthalic acid-adipic acid-butylene glycol ester, polylactic acid, and modified starch can be degraded. Polylactic acid and modified starch can provide nutrients for microorganisms in the degradation process that promote the reproduction of microorganisms, thereby improving the degradation rate. At the same time, the inorganic filler uses its rapid disintegration effect in the degradation process to promote the rapid separation of inorganic materials and polymers in the bag, increase the contact area between polymers and microorganisms, and further improve the degradation efficiency.

The increase of modified starch and inorganic fillers may reduce the proportion of polyethylene terephthalic acid-adipic acid-butylene glycol, thereby reducing the product cost. Also, the increase of modified starch and inorganic filler may make the finished bag have higher strength and better toughness so that it is of higher quality. At the same time, the plasticizer and compatibilizer in the modified starch may be matched with polyethylene terephthalic acid-adipic acid-butylene glycol ester and inorganic filler to improve the heat-sealing strength of the finished bag by using its good bonding compatibility.

In certain implementations, preferably, the weight ratio of described corn starch to tapioca starch may be 90:10-10:90. Tapioca starch may mainly be composed of starch molecules and amylase, and corn starch may contain starch molecules, proteins, and fatty acids. Starch molecules, amylases, proteins, and fatty acids promote the growth and reproduction of microorganisms, thereby promoting the degradation of finished bags.

Preferably, corn starch and tapioca starch can be loaded corn starch and loaded tapioca starch respectively. The loaded corn starch may be composed of corn starch, rhamnolipid solution, and perilla meal with a weight ratio of about 1:0.1-0.3:0.2-0.4. The loaded tapioca starch may be composed of tapioca starch, rhamnolipid solution, and perilla meal with a weight ratio of 1:0.1-0.3:0.2-0.4. The surface of corn starch and tapioca starch may be coated with the rhamnolipid solution, and then perilla meal powder may be bonded. The viscosity of rhamnolipid solution may be used to facilitate the adhesion of perilla meal powder, corn starch, and tapioca starch. Rhamnolipid has a hydrophilic and lipophilic end. The hydroxyl group in the hydrophilic end of rhamnolipid and the hydroxyl group in the starch molecule attract each other so that the hydrophobic end of rhamnolipid faces outward. Since perilla meal powder is prepared from perilla seed after oil extraction, the perilla meal powder may not only be porous in structure but also lipophilic, so as to facilitate the lipophilic end of rhamnolipid and perilla meal powder form more stable bonding.

Plastic films prepared by conventional methods are prone to moisture absorption when kept for a period of time. The starch molecules in the film absorb moisture resulting in internal molecular expansion, which causes surface precipitation problems. In addition, the film is prone to the problem of difficulty in heat sealing or heat-sealing strength decreases due to moisture absorption.

The disclosed invention combines corn starch, tapioca starch, rhamnolipid solution, and perilla meal powder. The surface of the starch granules may be loaded successively with rhamnolipid and perilla meal powder by coating the rhamnolipid solution and perilla meal powder. The hydrophobicity of perilla meal powder combined with the hydrophobicity of rhamnolipid solution close to the surface side of perilla meal powder prevents starch granules from absorbing moisture as much as possible. The film, according to the present invention, can be placed for a long period of time without the risk of moisture absorption by internal starch granules and internal expansion stress. In addition, the porous structure of perilla meal powder and the support network of rhamnolipid may provide space for the internal molecular expansion stress, if the internal expansion stress occurs anyhow. Thus, the precipitation of plasticizers and inorganic fillers caused by expansion stress may be avoided as much as possible. At the same time, the hot-melt adhesion of the rhamnolipid may further ensure the heat-sealing strength of the finished bag. The stable bonding of plasticizers and inorganic fillers may also ensure the mechanical strength of the finished bag so that the finished bag has a high quality and long service life.

Corn starch, tapioca starch, rhamnolipid solution, and perilla meal powder may further promote the growth and reproduction of microorganisms in the soil during degradation. The porous structure of perilla meal powder may additionally promote the growth and reproduction of microorganisms in the soil, thereby increasing the degradation rate. Moreover, the porous structure can further increase the contact area between microorganisms and the finished T bag which may further improve the degradation rate. At the same time, the rapid degradation of rhamnolipids, perilla meal, and starch granules may promote the rapid disintegration of the internal structure of the bag, thereby further increasing the contact area between microorganisms and various components in the bag and improving the overall degradation rate of the bag.

Preferably, the inorganic filler may include talc powder and/or calcium carbonate. By adopting the above-mentioned technical scheme, micron-level talcum powder and nano-scale calcium carbonate can be matched, and different gradation particle sizes can be used to make the plastic film structure of the bag denser. The higher strengths of the talc powder and the calcium carbonate may result in improving the mechanical strength and service life of the finished bag.

Preferably, the talc powder may be prepared by the modification of talcum powder particles by propolis liquid and hydrophobic cellulose filaments. Calcium carbonate may be prepared by the modification of calcium carbonate particles by propolis and hydrophobic cellulose filaments.

Untreated talcum powder and calcium carbonate, due to their small particle size, can cause a decrease in the heat-sealing effect and heat-sealing strength of a blown film when kept for a period of time due to moisture absorption. Combining the Talcum powder, calcium carbonate, propolis liquid, and hydrophobic cellulose filaments, the propolis melt may adhere to the surface of talc and calcium carbonate and fill the pores of part of the cellulose filaments. Water resistance of propolis and the hydrophobic effect of the hydrophobic cellulose filaments may prevent the cellulose filaments, talcum powder, and calcium carbonate from absorbing moisture, thus improving the heat-sealing strength of the finished bag. The cellulose filament flexibility may further increase the specific surface area of the talc and the calcium carbonate, which improves the contact area of the talc, the calcium carbonate, and the polymer material. This may also improve the stability of bonding and can prevent the calcium carbonate and talc from agglomeration. Even when placed for a period of time after blowing the film, the calcium carbonate and the talc remain evenly and stably dispersed in the bag. With the hydrophobicity of coagulants, hydrolysis agents, lubricants, and propolis, it may not be easy to make the internal raw materials of the bag hygroscopic. This may ensure the heat-sealing effect and heat-sealing strength of the T-shirt bag.

Degradability of the Propolis and cellulose filaments may ensure the biodegradability of the bag. The surface of the propolis may be lipophilic, which may be convenient to attract and connect with the modified starch, to improve the bonding stability between the raw materials inside the bag. The finished bag has the advantages of degradability, high mechanical strength, and high heat-sealing strength.

Preferably, the hydrophobic cellulose filament may be prepared by hydrophobic modification of cellulose filament with methyl silicone oil. The softening and dispersibility of methyl silicone oil may improve the flexibility of cellulose filament and give cellulose filament the effect of hydrophobicity, and at the same time facilitate cooperation with additives such as coagulant, chain extender, anti-hydrolysis agent, etc. This improves the bonding compatibility of each raw material, thereby improving the structural density of the bag so that the bag has good mechanical strength. The high heat-sealing strength and long service life, even when placed or used in a humid environment, ensures that the bag has a long service life.

Preferably, the coagulant may be composed of sodium polyacrylate and microcrystalline wax with a weight ratio of 1:0.1-0.3. Through the adoption of the said technical scheme, sodium polyacrylate and microcrystalline can be matched. The carboxyl group in sodium polyacrylate may be matched with polylactic acid, polyterephthalic acid-adipic acid-butylene glycol ester, and inorganic filler. The inorganic filler can be fused and bonded with polyethylene terephthalic acid-adipic acid-butylene glycol ester and polylactic acid by using the anchor connection principle, which not only improves the mechanical strength of the finished product but also improves the heat-sealing strength of the finished product. Microcrystalline wax has a good lubricating effect, which can smooth the bonding surface of inorganic fillers and polymer materials such as polyethylene terephthalic acid-adipic acid-butylene glycol, so that the film surface is smooth and free of flocculent particle agglomeration, thereby improving the quality of the finished bag.

Preferably, the chain extender may be an oligomer of styrene-acrylic acid-propylene methacrylate. The oligomers of styrene-acrylic acid-propylene methacrylate, polyethylene terephthalic acid-adipic acid-butylene glycol, inorganic fillers, modified starch, and polylactic acid all may be combined to expand the molecular chain and improve the adhesion compatibility between the raw materials of the bag, thereby improving the mechanical strength of the finished bag and prolonging the service life of the bag.

Preferably, the anti-hydrolysis agent may be a polymeric carbodiimide anti-hydrolysis agent. The oligomers of the amino group, inorganic filler, polylactic acid, and styrene-acrylic acid-propylene methacrylate in the polymeric carbodiimide anti-hydrolytic agent may be combined to improve the adhesion compatibility between the basic raw materials, to achieve the effect of water resistance by increasing the structural density. In addition, the polymeric carbodiimide anti-hydrolysis agent may combine with the hydrophobic group on the surface of the modified fiber and the propolis of the inorganic filler to further improve the hydrophobicity of the finished bag, so that the bag has good hydrolysis resistance, high mechanical strength and long service life. And the finished bag may have high heat-sealing strength.

In certain implementations, disclosed is a preparation method for fully biodegradable bags including the following steps. First, polyterephthalic acid-adipic acid-butylene glycol ester and polylactic acid may be mixed evenly, and then modified starch, inorganic filler, coagulant, anti-hydrolysis agent, chain extender, and lubricant may be added and mixed evenly to prepare a mixture. Then the mixture may be extruded and granulated to obtain blown film resin. The blown film resin may be processed by a blown film machine to obtain a blended film. The finished T-shirt bag prepared by the disclosed method may have several advantages including low cost, high quality, high heat-sealing strength, and that may be completely biodegradable after use.

Polyethylene terephthalic acid-adipic acid-butylene glycol, polylactic acid, and modified starch may be degraded, and the increase of modified starch and inorganic fillers may reduce the addition of polyethylene terephthalic acid-adipic acid-butylene glycol, thereby reducing the cost of products. Moreover, the increase of modified starch and inorganic fillers may result in the finished bag having higher strength and better toughness so that it is of higher quality. At the same time, the plasticizer and compatibilizer in the modified starch may be matched with polyethylene terephthalic acid-adipic acid-butylene glycol ester and inorganic filler to improve the heat-sealing strength of the finished bag by using its good bonding compatibility.

Combining corn starch, tapioca starch, rhamnolipid solution, perilla meal powder, the hydrophobicity of perilla meal powder and the hydrophobicity of rhamnolipid solution near the surface of perilla meal powder may prevent the starch granules from absorbing moisture and reduce internal swelling. In addition, the porous structure of perilla meal powder may cooperate with the support network of rhamnolipid to provide space for the internal molecular expansion stress. This helps to avoid the phenomenon of plasticizers and inorganic filler precipitation caused by expansion stress. This may ensure that the finished bag has high heat-sealing strength.

Talcum powder, calcium carbonate, propolis liquid, and cellulose filaments are used to prevent cellulose filaments, talcum powder, and calcium carbonate from absorbing moisture, and improve the heat-sealing strength of the finished bag.

### Preparation of Loaded Corn Starch

The rhamnolipids in the following raw materials were purchased from Wuhan Huaxiang Kejie Biotechnology Co., Ltd.; Other raw materials and equipment are commercially available.

### Example 1: Preparation of Loaded Cornstarch

The rhamnolipid solution was composed of rhamnolipid methanol solution with a mass fraction of 1%, and the mass fraction of methanol 90% was used. Perilla meal was obtained after oil extraction. The perilla meal was dispersed and dried to obtain perilla meal powder that passed through an 800-mesh sieve. In 1 kg of corn starch 0.2 kg of the rhamnolipid solution was sprayed evenly at a speed of 20 g rhamnolipid per minute, with stirring at a speed of 80 r/min during the addition process, stirred and mixed evenly. Then 0.3 kg of perilla meal powder was evenly sprayed over the coated corn starch, dried, and dispersed, to obtain a finished product.

### Example 2

Similar to Example 1, except 0.1 Kg of rhamnolipid solution was used for 1 Kg of corn starch. The addition speed of rhamnolipid was 20 g/min, stirred at a speed of 80 r/min during the addition process, stirred, and mixed evenly. Then 0.2 kg perilla meal powder was evenly spread over the coated corn starch, dried, and dispersed, to obtain a finished product.

### Example 3

Same as Example 1, but 0.3 kg of the rhamnolipid solution was evenly sprayed over 1 kg of corn starch at a speed of 20 g/min with stirring at a speed of 80 r/min, stirred and mixed evenly. Then 0.4 kg of perilla meal powder was sprayed followed by drying and dispersing to obtain a finished product.

### Preparation of Loaded Tapioca Starch

### Example 4

The rhamnolipid solution in the form of rhamnolipid methanol solution with a mass fraction of 1% and methanol in a mass fraction of 90% was used. Perilla meal was obtained after oil extraction. The perilla meal was dispersed and dried to obtain perilla meal powder, which passed through an 800 mesh sieve.

0.2 kg of rhamnolipid solution was evenly sprayed over 1 kg of tapioca starch at a speed of about 20 g/min while stirring at about 80 r/min. 0.3 kg of perilla meal powder was then evenly sprayed, dried, and dispersed to obtain a finished product.

### Example 5

Same as example 1 except, 0.1 kg of the rhamnolipid solution was evenly sprayed over 1 kg of tapioca starch at a speed of 20 g/min with stirred at 80 r/min, stirred and mixed evenly, and then evenly sprayed with 0.2 kg perilla meal powder, dried and dispersed, the finished product was prepared.

### Example 6

Same as example 4 except 0.3 kg of rhamnolipid solution was evenly sprayed over 1 kg of tapioca starch at 20 g/min with stirring at a speed of 80 r/min, stirred, and mixed evenly. Then 0.4 kg of perilla meal powder was sprayed, dried, and dispersed to obtain a finished product.

### Example of Preparation of Modified Starch

The anti-migration agent in the following raw materials was purchased from Shanghai Qianbao Fine Chemical Co., Ltd.; Model PA-107. All other raw materials were commercially available.

### Example 7

53.7 kg of corn starch, 20 kg of tapioca starch, 10 kg of plasticizer, 0.2 kg compatibilizer, 0.3 kg coupling agent, and 0.3 kg of anti-migration agent were blended into a high-speed mixer, stirred at a speed of 1000 r/min for 15 min, the material reached 80° C., and the modified starch was prepared. The plasticizer used was glycerol, the compatibilizer was maleic anhydride and the coupling agent was silane coupling agent KH-570.

### Example 8

Same as Example 7, except weigh 10 kg of corn starch, 90 kg of tapioca starch, 2 kg plasticizer, 0.1 kg compatibilizer, 0.1 kg coupling agent, and 0.2 kg of anti-migration agent into a high-speed mixer, stir at a speed of 1000 r/min for 10 min, the material reaches 70° C., and the modified starch was prepared. Cornstarch and tapioca are both commonly commercially available. The plasticizer used was glycerol. The compatibilizer used was maleic anhydride. The coupling agent used was silane coupling agent KH-570.

### Example 9

Same as Example 7 except weigh 90 kg of corn starch, 10 kg of tapioca starch, 12 kg of plasticizer, 0.3 kg compatibilizer, 1 kg coupling agent, and 0.6 kg of anti-migration agent into a high-speed mixer, stirred at a speed of 1000 r/min for 30 min, the material reaches 100° C., discharge, and the modified starch was prepared.

### Example 10

Same as Example 7 except the loaded corn starch of Example 1 and loaded tapioca starch of Example 4 were used.

### Example 11

Same as Example 10 except the loaded corn starch of Example 2 and loaded tapioca starch of Example 5 were used.

### Example 12

Same as Example 10 except the loaded corn starch of Example 3 and loaded tapioca starch of Example 6 were used.

### Talcum Powder Preparation

### Example 13

Weigh 100 g of cellulose filaments and soak and disperse them in 1000 g of methyl silicone oil, the length of cellulose filaments is 10 μm, and the diameter is 5 nm. During the soaking process, the speed of dispersion and stirring is 1000 r/min, and the stirring time is 15 min, and then the cellulose filaments are filtered out and dried to obtain hydrophobic cellulose filaments.

The particle size of the talcum powder particles is 10 μm. Propolis liquid is prepared by heating the propolis to 100° C. and softening the hot melt.

0.1 kg hydrophobic cellulose filament is evenly sprayed on the surface of 1 kg carrier talc, the spraying speed of hydrophobic cellulose filament is 30 g/min, and the stirring speed of carrier talc during the spraying process is 200 r/min, and then the finished talc powder is prepared by drying and dispersion; Talcum powder passes through 800 mesh sieve.

### Preparation of Calcium Carbonate

### Example 14

Weigh 100 g of cellulose filaments, soak, and disperse it in 1000 g of methyl silicone oil, the length of cellulose filaments is 10 μm, and the diameter is 5 nm. During the soaking process, the speed of dispersion and stirring is 1000 r/min, and the stirring time is 15 min, and then the cellulose filaments are filtered out and dried to obtain hydrophobic cellulose filaments.

Weigh 1 kg of calcium carbonate granules, mix with 0.2 kg of propolis, and stir evenly. The particle size of calcium carbonate particles is 80 nm. Propolis is propolis particles with a particle size of 100 nm. The addition speed of propolis is 30 g/min, and the calcium carbonate particles are stirred at a speed of 80 r/min during the addition process, and then heated to 100° C. and stirred for 5 s to prepare the carrier calcium carbonate.

0.1 kg hydrophobic cellulose filament is evenly sprayed on the surface of 1 kg carrier calcium carbonate, the spraying speed of hydrophobic cellulose filament is 30 g/min, and the stirring speed of carrier calcium carbonate in the spraying process is 200 r/min. Then the finished calcium carbonate is prepared by drying and dispersing, and the particle size of the finished calcium carbonate is less than 500 nm.

### EMBODIMENTS

The sodium polyacrylate in the following raw materials was purchased from Jiangsu Caiwei Biotechnology Co., Ltd.; Polymeric carbodiimide anti-hydrolytic agent was purchased from Shanghai Langyi Functional Materials Co., Ltd.; Ethylene bistearate amide was purchased from Shandong Kepler Biotechnology Co., Ltd.; Styrene-acrylic-propylene methacrylate oligomers were purchased from Qingdao Linke Industry and Trade Co., Ltd., model CXP5045; Other raw materials and equipment are generally commercially available.

### Embodiment 1: Preparation of a Fully Biodegradable T-Shirt Bag

71 kg of polyterephthalate-adipic acid-butylene glycol, 3 kg of polylactic acid, 15 kg of modified starch, 10 kg of inorganic filler, 0.5 kg of coagulant, 0.2 kg of anti-hydrolysis agent, 0.1 kg of chain extender, 0.2 kg of lubricant. The weight average molecular weight of polyterephthalic acid-adipic acid-butylene glycol ester is 50,000 g/mol. The modified starch of example 7 is used. The inorganic filler is commercially available calcium carbonate with a particle size of 100 nm. The coagulant is sodium polyacrylate; the anti-hydrolysis agent is a polymeric carbodiimide anti-hydrolysis agent; the chain extender is an oligomer of styrene-acrylic acid-propylene methacrylate; and the lubricant is ethylene bistearateamide.
(S1) polyterephthalic acid-adipic acid-butylene glycol ester and polylactic acid are mixed in a high-speed mixer and stirred at a speed of 3000 r/min for 3 min to obtain mixture A. The modified starch, inorganic filler, coagulant, hydrolysis inhibitor, chain extender, and lubricant were stirred for 3 min to obtain mixture B.
(S2) mixture A is put into the main feeder and mixture B is put into the side feeder. Then extruded and granulated under the condition of an extruder temperature of 160° C. and the speed of the host screw is 250 r/min. After extrusion, it is successively air-cooled, granulated, and dried to obtain blown film resin. The blown film resin is placed in the blown film machine, and the blown film is processed under the condition of 150° C., the speed of the main engine screw 200 r/min, the traction speed 15 m/min, and the blowing ratio 4 to prepare the blended film.
(S3) Finished T-shirt bag is prepared by processing the blended film in a bag-making machine at a temperature of about 180° C. The bag of thickness is 30 μm was obtained.

### Embodiment 2

Embodiment 2 differs from embodiment 1 in that 55 kg of polyterephthalic acid-adipic acid-butanediol ester, 1 kg of polylactic acid, 5 kg of modified starch, 5 kg of inorganic filler, 0.5 kg of coagulant, 0.2 kg of hydrolysis inhibitor, 0.1 kg of chain extender, 0.1 kg of lubricant, and the modified starch of example 8 is added.

### Embodiment 3

Embodiment 3 differs from Embodiment 1 in that 90 kg of polyterephthalic acid-adipic acid-butylene glycol, 5 kg of polylactic acid, 30 k g of modified starch, 30 kg of inorganic filler, 1.5 kg of coagulant, 0.6 kg of anti-hydrolysis agent, 0.3 kg of chain extender, 0.5 kg of lubricant, and the modified starch of Example 9 were added.

### Embodiment 4

The present embodiment differs from Embodiment 1 in that 70 kg of polyterephthalic acid-adipic acid-butylene glycol, 3 kg of polylactic acid, 15 kg of modified starch, 18 kg of inorganic filler, 1.2 kg of coagulant, 0.5 kg of anti-hydrolysis agent, 0.2 kg of chain extender, and 0.3 kg of lubricant were used.

The modified starch of Example 10 was used. The inorganic filler is composed of talc and calcium carbonate with a weight ratio of 2:1. Talc powder of Example 13 is selected, and calcium carbonate was prepared as in Example 14. The coagulant consists of sodium polyacrylate with a weight ratio of 1:0.2 and microcrystalline wax.

### Embodiment 5

Embodiment 5 differs from embodiment 4 in that the 1.1 kg of coagulant; modified starch of Example 11; and inorganic filler composed of talc and calcium carbonate with a weight ratio of 2:1 was used. The talc powder of example 13 and calcium carbonate of Example 14 were used. The coagulant consists of sodium polyacrylate with a weight ratio of 1:0.1 and microcrystalline wax.

### Embodiment 6

The present embodiment differs from Embodiment 4 in that 1.3 kg of coagulant, modified starch of Example 12, and inorganic filler of talc and calcium carbonate in a weight ratio of 2:1. Talc of Example 13, and calcium carbonate of Example 14. The coagulant consists of sodium polyacrylate with a weight ratio of 1:0.3 and microcrystalline wax.

### Embodiment 7

Embodiment 7 from Embodiment 4 in that Loaded corn starch and loaded tapioca starch are not added with perilla meal powder.

### Embodiment 8

Embodiment 8 differs from embodiment 4 in that the rhamnolipid solution is replaced with a carboxymethyl cellulose solution of the same quality in the loaded corn starch and the loaded tapioca starch.

### Embodiment 9

Embodiment 9 differs from Embodiment 4 in that in the preparation of talc and calcium carbonate, there are no hydrophobic cellulose filaments on the surface of talc particles and calcium carbonate particles.

### Embodiment 10

Embodiment 10 differs from Embodiment 4 in that in the preparation of talc and calcium carbonate, hydrophobic filaments are replaced with filaments of the same quality, i.e., cellulose filaments are not treated with methyl silicone.

### Proportional to the Pair

### Pair Ratio 1

This pair ratio differs from Embodiment 1 in that in the process of preparing modified starch: 75 parts of corn starch and 25 parts of sorbitol were weighed, added to a high-speed mixer, and stirred at a speed of 1000 r/min for 15 min to obtain modified starch.

### Pair Ratio 2

Pair ratio 2 differs from Embodiment 1 in that no inorganic fillers, hydrolysis inhibitors, and coagulants were added to the raw materials.

### Performance Testing

### Mechanical Strength Testing

The finished T-shirt bags were prepared as described in Embodiments 1-10 and the proportion 1-2 respectively, and the tensile strength and the heat-sealing strength of the bottom of the bags were detected with reference to GB/T1040-2006, and the data were recorded.

### Water Resistance Test

The blended films were prepared according to Embodiments 1-10 and the proportion 1-2 respectively. The blended films were placed at a relative humidity of 90% and temperature of about 30° C. for 24 h, and then the T-shirt bags were prepared. The tensile strength and the heat-sealing strength of the bottom of the bag after wet treatment were detected with reference to GB/T1040-2006 again, and the data were recorded.

### Degradability Detection

The finished T-shirt bag was prepared as described in Embodiments 1-7 and 9 respectively. The T-shirt bags were placed in the soil with a relative humidity of 70% and a temperature of 20° C. The composting degradation rate was recorded after 60 days, and the data was recorded.

TABLE 1
Performance test table

| | Tensile | | Heat sealing | | |
|---|---|---|---|---|---|
| | strength/MPa | | strength/N/15 cm | | |
| | | Wet | | Wet | Degradation |
| project | initial | processing | initial | processing | rate/% |
| Embodiment 1 | 35.4 | 33.3 | 16.0 | 13.7 | 82.5 |
| Embodiment 2 | 33.8 | 31.1 | 15.2 | 12.5 | 80.0 |
| Embodiment 3 | 35.7 | 33.8 | 16.4 | 14.3 | 83.4 |
| Embodiment 4 | 37.8 | 37.0 | 17.4 | 16.4 | 86.7 |
| Embodiment 5 | 37.3 | 36.0 | 17.2 | 15.9 | 85.6 |
| Embodiment 6 | 38.0 | 37.3 | 17.5 | 16.6 | 87.1 |
| Embodiment 7 | 36.5 | 35.2 | 16.5 | 15.0 | 84.5 |
| Embodiment 8 | 37.1 | 35.5 | 16.9 | 14.9 | / |
| Embodiment 9 | 36.9 | 35.8 | 16.6 | 15.3 | 85.3 |
| Embodiment 10 | 37.4 | 35.9 | 17.1 | 15.4 | / |
| Pair scale 1 | 31.2 | 28.0 | 14.4 | 11.0 | / |
| Pair scale 2 | 27.6 | 23.7 | 11.7 | 7.6 | / |

Referring to Table 1, Embodiments 1-3 show that prepared T-shirt bags have high tensile strength and heat-sealing strength, the degradation rate is fast, the production cost is low, high-quality, high heat-sealing strength, and can be completely biodegradable after use.

Embodiments 1 and 4-6 in Table 1 show that modified tapioca starch and modified corn starch can improve the adhesion compatibility of modified starch, inorganic filler, and polymer material, thereby improving mechanical strength. After treatment, the starch molecules do not quickly absorb the water. Also, talcum powder and calcium carbonate do not easily absorb moisture in a humid environment, so the plastic film is placed for a period of time before preparing the T-shirt bag. Also, the mechanical properties and heat-sealing strength are not affected easily, so as to ensure the service life of the T-shirt bag. At the same time, after treatment, it can accelerate the degradation efficiency and promote the degradation of the T-shirt bag.

In Embodiments 4 and 7-10 in Table 1, it can be seen that the T-shirt bag made according to Embodiment 7 i.e., not having the perilla meal powder, shows lower tensile strength and heat-sealing strength compared with Embodiment 4. After wet treatment, the loss value of tensile strength and heat-sealing strength is greater than the loss value corresponding to Embodiment 4, and the degradation rate is lower than that of Embodiment 4. These results indicate that perilla meal powder could prevent starch separation and agglomeration, water absorption, ensure mechanical strength and heat-sealing strength, provide nutrients for the growth and reproduction of microorganisms, and promote the degradation of T-shirt bags.

In embodiment 8, the loaded corn starch and the loaded tapioca starch replace the rhamnolipid solution with a carboxymethyl cellulose solution of the same quality, compared with Embodiment 4. The tensile strength and the heat-sealing strength of the T-shirt bag prepared in Embodiment 8 are lower than those in Embodiment 4. After wet treatment, the loss values of the tensile strength and the heat-sealing strength are greater than the corresponding loss values of Embodiment 4. It shows that carboxymethyl cellulose is hydrophilic and absorbent, and due to its hygroscopicity after wet treatment, it is easy to affect the mechanical strength and heat-sealing strength of the finished T-shirt bag. The hydrophilic end easily adheres to the surface of starch molecules, while the hydrophobic end faces outward and bonds with the hydrophobic perilla meal powder, so as to achieve good dispersion of starch molecules and prevent starch molecules from absorbing water and affecting the processing performance of the T-shirt bag.

In the process of preparing talcum powder and calcium carbonate in Embodiment 9, there are no hydrophobic cellulose filaments on the surface of talc powder particles and calcium carbonate particles, compared with Embodiment 4. The tensile strength and heat-sealing strength of the T-shirt bag prepared in Embodiment 9 are lower than those in Embodiment 4, and after the wet treatment, the loss value of tensile strength and heat-sealing strength is greater than the loss value corresponding to Embodiment 4. And the degradation rate is less than that of Embodiment 4. The results indicate that the addition of hydrophobic cellulose filaments could not only promote dispersion but also promote the growth and reproduction of microorganisms and increase the degradation rate. At the same time, the hot melt flow effect in the process of propolis heat sealing is convenient for blocking the pore structure of cellulose filaments, and the hydrophobic effect of hydrophobic filaments prevents moisture absorption while ensuring the strength of the T-shirt bag.

In the process of preparing talcum powder and calcium carbonate in Embodiment 10, the cellulose filament is not treated with methyl silicone oil and is an ordinary commercially available cellulose filament, compared with Embodiment 4. The tensile strength and heat-sealing strength of the T-shirt bag prepared in Embodiment 10 are lower than those in Embodiment 4, and after the wet treatment, the loss value of tensile strength and heat-sealing strength is greater than the corresponding loss value of Embodiment 4. The results indicated that cellulose filaments could avoid hygroscopic absorption by talc and calcium carbonate as much as possible after hydrophobicity. The non-hydrophobic filaments could easily affect the heat-sealing and mechanical strengths due to the hygroscopic problem.

In Embodiment 1 and pair ratio 1-2 in Table 1, it can be seen that the modified starch of Proportion 1 is only mixed with sorbitol, and compared with Embodiment 1, the tensile strength and heat sealing strength of the T-shirt bag prepared for proportion 1 are less than that of Embodiment 1, and the loss value of tensile strength and heat sealing strength after wet treatment is greater than that corresponding to Embodiment 1. It shows that corn starch and tapioca starch modified by plasticizer, compatibilizer, and anti-migration agent can make the finished T-shirt bag have high mechanical strength and heat-sealing strength.

In Proportion 2, inorganic fillers, anti-hydrolysis agents, and coagulants are not added to the raw materials, the tensile strength and heat-sealing strength of the T-shirt bag prepared in Proportion 2 are less than those of Embodiment 1, and the loss values of tensile strength and heat-sealing strength after wet treatment are greater than those corresponding to Embodiment 1. It shows that the addition of inorganic fillers increases the mechanical strength of the T-shirt bag, while the addition of hydrolysis resistance and coagulant can improve the waterproofness and prolong the service life of the T-shirt bag.

The above-described embodiments are only an interpretation of the present application and are not intended to restrict the scope of the present application. Those skilled in the art may, after reading the present specification, make modifications to the specified embodiment without inventive contribution as needed, but as long as they are protected by patent law within the scope of the claims of the present application.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A biodegradable bag made of the following weight parts of raw materials:
polyterephthalic acid-adipic acid-butylene glycol ester 55-90 parts,
polylactic acid 1-5 parts,
modified starch 5-30 parts,
inorganic filler 5-30 parts,
coagulant 0.5-1.5 parts,
hydrolysis agent 0.2-0.6 parts,
chain extender 0.1-0.3 parts, and
lubricant 0.1-0.5 parts.

2. The biodegradable bag of claim 1, wherein the modified starch is a mixture of corn starch and tapioca starch, each modified by a modifier, the modifier comprises:
2-12 weight parts plasticizer,
0.1-0.3 weight parts compatibilizer,
0.1-1 weight parts coupling agent, and
0.2-0.6 weight parts anti-migration agent.

3. The biodegradable bag of claim 2, wherein a weight ratio of the corn starch to the tapioca starch is 10-90:10-90.

4. The biodegradable bag of claim 2, wherein the corn starch and tapioca starch are respectively loaded corn starch and loaded tapioca starch, wherein the loaded corn starch comprises corn starch, rhamnolipid solution, and perilla meal powder in a weight ratio of 1:0.1-0.3:0.2-0.4; and wherein the loaded tapioca starch comprises tapioca starch, rhamnolipid solution, and perilla meal in a weight ratio of 1:0.1-0.3:0.2-0.4.

5. The biodegradable bag of claim 1, wherein the inorganic filler is talcum powder and/or calcium carbonate.

6. The biodegradable bag of claim 5, wherein the talcum powder comprises talcum powder particles modified by propolis liquid and hydrophobic cellulose filaments, wherein the calcium carbonate comprises calcium carbonate particles modified by propolis and hydrophobic cellulose filaments.

7. The biodegradable bag of claim 6, wherein the hydrophobic cellulose filament comprises cellulose filaments modified with methyl silicone oil.

8. The biodegradable bag of claim 1, wherein the coagulant comprises sodium polyacrylate and microcrystalline wax in a weight ratio of 1:0.1-0.3.

9. The biodegradable bag of claim 1, wherein the chain extender is an oligomer of styrene-acrylic acid-propylene methacrylate.

10. The biodegradable bag of claim 1, wherein the anti-hydrolysis agent is a polymeric carbodiimide anti-hydrolysis agent.

11. A method of preparing a biodegradable bag, the method comprises:
mixing polyterephthalic acid-adipic acid-butylene glycol ester and polylactic acid;
upon mixing, adding modified starch, inorganic filler, coagulant, anti-hydrolysis agent, chain extender, and lubricant to obtain a mixture;
extruding and granulating the mixture to obtain blown film resin; and
processing the blown film resin to obtain a blended film.

12. The method of claim 11, wherein the modified starch is a mixture of corn starch and tapioca starch, each modified by a modifier, the modifier comprises:
2-12 weight parts plasticizer,
0.1-0.3 weight parts compatibilizer,
0.1-1 weight parts coupling agent, and
0.2-0.6 weight parts anti-migration agent.

13. The method of claim 12, wherein a weight ratio of the corn starch to the tapioca starch is 10-90:10-90.

14. The method of claim 12, wherein the corn starch and tapioca starch are respectively loaded corn starch and loaded tapioca starch, wherein the loaded corn starch comprises corn starch, rhamnolipid solution, and perilla meal powder in a weight ratio of 1:0.1-0.3:0.2-0.4; and wherein the loaded tapioca starch comprises tapioca starch, rhamnolipid solution, and perilla meal in a weight ratio of 1:0.1-0.3:0.2-0.4.

15. The method of claim 11, wherein the inorganic filler is talcum powder and/or calcium carbonate.

16. The method of claim 15, wherein the talcum powder comprises talcum powder particles modified by propolis liquid and hydrophobic cellulose filaments, wherein the calcium carbonate comprises calcium carbonate particles modified by propolis and hydrophobic cellulose filaments.

17. The method of claim 16, wherein the hydrophobic cellulose filament comprises cellulose filaments modified with methyl silicone oil.

18. The method of claim 11, wherein the coagulant comprises sodium polyacrylate and microcrystalline wax in a weight ratio of 1:0.1-0.3.

19. The method of claim 11, wherein the chain extender is an oligomer of styrene-acrylic acid-propylene methacrylate.

20. The method of claim 11, wherein the anti-hydrolysis agent is a polymeric carbodiimide anti-hydrolysis agent.
